(19) United States
(12) Patent Application Publication
(10) Pub. No.: US 2010/0282582 A1
(43) Pub. Date: Nov. 11, 2010

(54) SWITCH APPARATUS

(75) Inventor: CHIEN-CHUN FU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/511,269

(22) Filed: Jul. 29, 2009

(30) Foreign Application Priority Data
May 8, 2009 (CN) 200910302184.6

(51) Int. Cl. H01H 9/00

(52) U.S. Cl. 200/314

(57) ABSTRACT

A switch apparatus includes a Light Emitting Diode (LED) housing and a light guide pole. The LED housing includes at least one LED light source and a switch. The switch is capable of being actuated to light the at least one LED light source. The light guide pole is capable of transmitting light. The light guide pole is removably embedded in the LED housing to contact with the switch. The light guide pole presses the switch to drive the at least one LED light source to light.

### BACKGROUND

1. Technical Field

The present disclosure relates to a switch apparatus and, particularly, to a switch apparatus with Light Emitting Diode.

2. Description of Related Art

Buttons are typically used in electronic devices to control the power to start up an operation of the electronic device. An indication light is usually positioned adjacent to the button to indicate a working state of the electronic device. The indication light and the button are separate parts. It needs a plurality of accessories and occupies large space.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view of a first embodiment of a switch apparatus.

FIG. 2 is a schematic view of a second embodiment of the switch apparatus.

FIG. 3 is a schematic view of a third embodiment of the switch apparatus.

FIG. 4 is a schematic view of a top portion of a light guide pole of the switch apparatus.

FIG. 5 is a schematic view of the light guide pole and a LED housing of the switch apparatus.

FIG. 6 is a schematic view of package types of the switch apparatus.

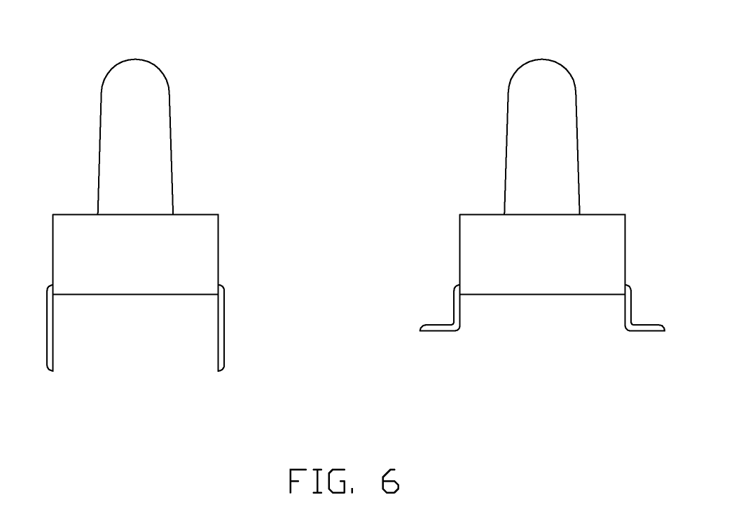

### DETAILED DESCRIPTION

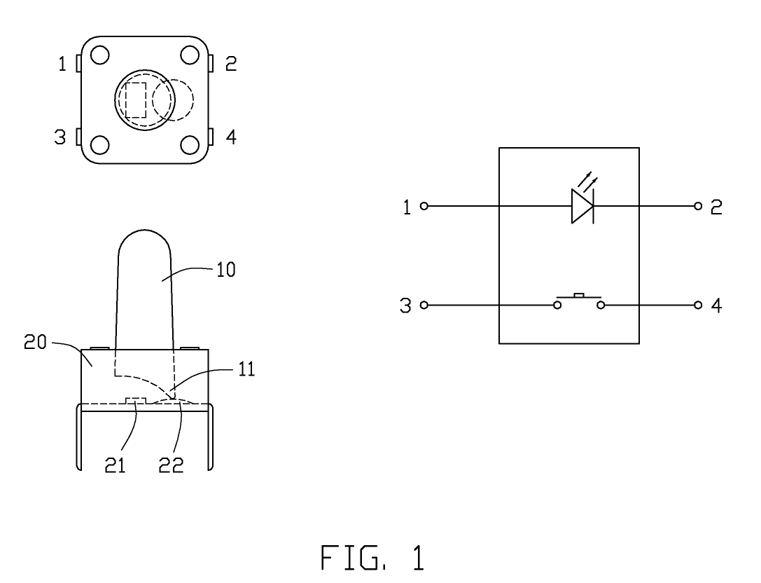

Referring to FIG. 1, a switch apparatus in a first embodiment includes a light guide pole 10 and a Light Emitting Diode (LED) housing 20. A pressing portion 11 projects from a bottom portion of the light guide pole 10. The light guide pole 10 is embedded in the LED housing 20. The LED housing 20 includes a LED 21 and a resilient piece 22 adjacent to the LED 21. The LED 21 and the metal piece 22 are located under the light guide pole 10. The LED 21 emits light in a single color.

The LED housing 20 may be encapsulated by dual in-line package (DIP). In microelectronics, a dual in-line package (DIP), is an electronic device package with a rectangular housing and two parallel rows of electrical connecting pins. The LED housing 20 may be encapsulated by Surface-mount technology (SMT). Surface-mount technology (SMT) is a method for constructing electronic circuits in which the components (SMC, or Surface Mounted Components) are mounted directly onto the surface of printed circuit boards (PCBs).

The LED housing 20 has four pins, pin 1, pin 2, pin 3, and pin 4. The LED light source 21 is connected between the pin 1 and the pin 2. A switch is connected between the pin 3 and the pin 4 to turn on the LED light source 21. The pressing portion 11 resists against the metal piece 22 to light the LED light source 21.

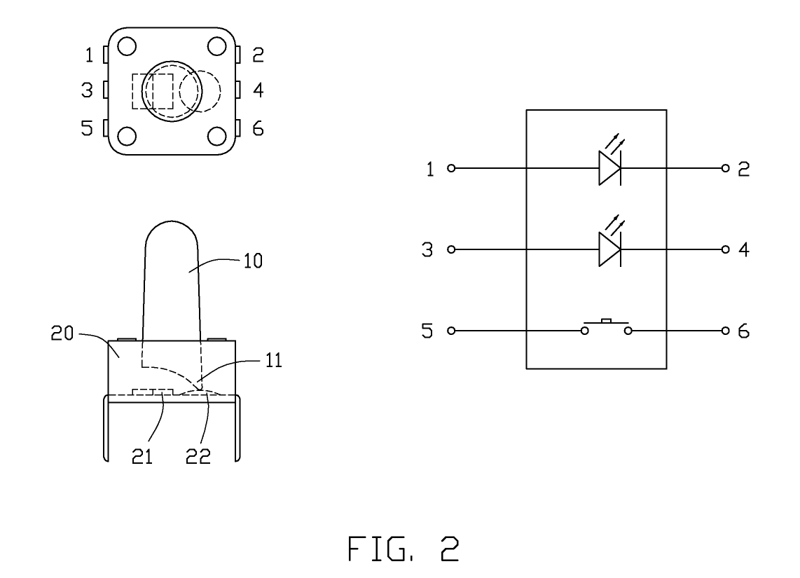

Referring to FIG. 2, a switch apparatus in a second embodiment includes six pins and two parallel LED light sources 21 in the LED housing 20. When a first LED light source is connected between the pin 1 and the pin 2, the first LED light source emits a first light color. When a second LED light source is connected between the pin 3 and the pin 4, the second LED light source emits a second light color. The switch is connected between the pin 5 and the pin 6. The LED light sources 21 can be controlled by Pulse-width modulation (PWM) to emit different light colors.

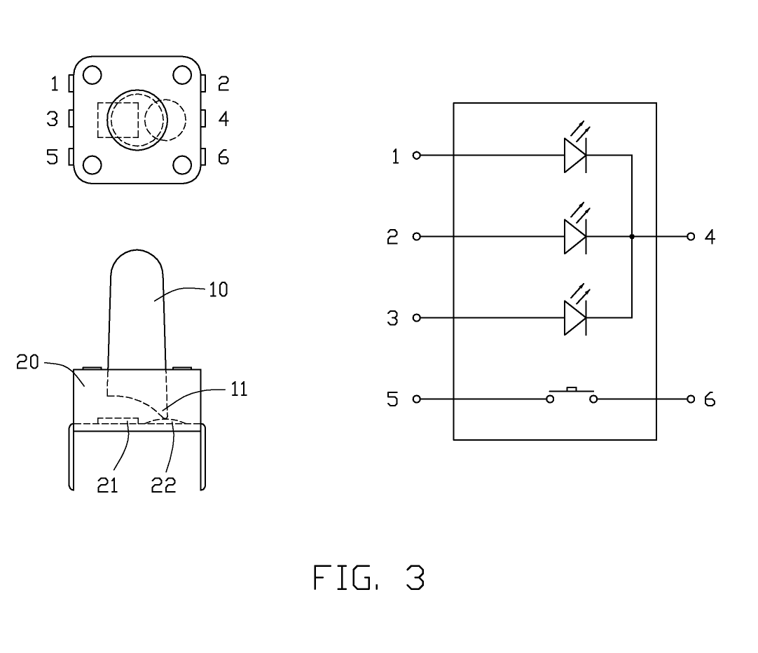

Referring to FIG. 3, a switch apparatus in a third embodiment includes three LED light sources 21 and six pins in the LED housing 20. The LED light sources 21 emit light in red, green, and blue colors correspondingly. A first LED light source is connected between the pin 1 and the pin 4. A second LED light source is connected between the pin 2 and the pin 4. A third LED light source is connected between the pin 3 and the pin 4. The pin 4 is a common pin. The switch is connected between the pin 5 and the pin 6 to light the LED light sources 21. The LED light sources 21 are controlled by PWM to light multiple colors light consisting of red, green, blue colors.

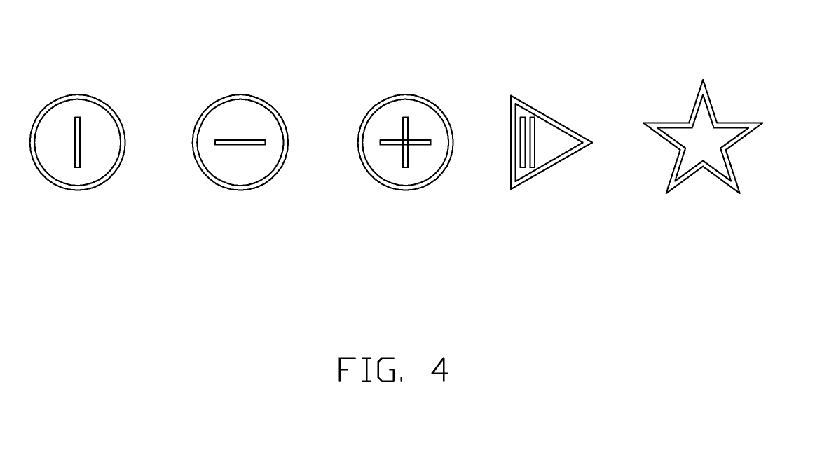

Referring to FIG. 4, different patterns are formed on a top portion of the light guide pole 10 to direct the corresponding functions. For example, power function, decreasing function, adding function, playing function, and so on.

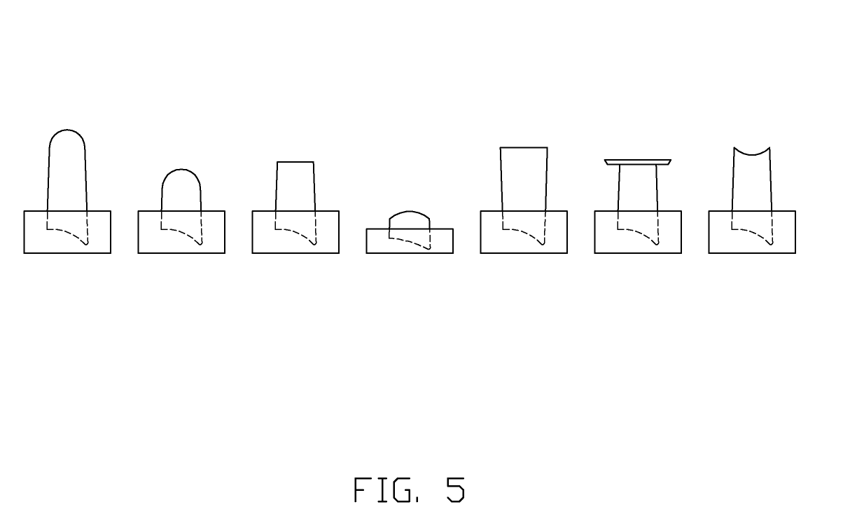

Referring to FIG. 5, heights and shapes of the light guide pole 10 and the LED housing 20 may be changed according to need and/or preference. For example, decrease the height of the light guide pole 10, decrease the height of the LED housing 20, and so on. The light guide pole 10 may be generally transparent, translucent, fogged, or dyed.

It is to be understood, however, that even though numerous characteristics and advantages of the disclosure have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A switch apparatus, comprising:
a light emitting diode (LED) housing comprising at least one LED light source and a switch, the switch capable of being triggered to light the at least one LED light source; and
a light guide pole being capable of transmitting light from the at least one LED light source; the light guide pole removably embedded in the LED housing, wherein the light guide pole is capable of pressing the switch to trigger the at least one LED light source to light by moving relative to the LED housing.

2. The switch apparatus of claim 1, wherein the switch is a resilient metal piece.

3. The switch apparatus of claim 2, wherein the metal piece is located under the light guide pole.

4. The switch apparatus of claim 2, wherein a pressing portion is formed on a bottom portion of the light guide pole.

5. The switch apparatus of claim 1, wherein each LED light source produces a single light color; a plurality of parallel LED light sources have different color light.

6. The switch apparatus of claim 5, wherein a plurality of parallel LED light sources produce light with pulse-width modulation.

7. The switch apparatus of claim 1, wherein the LED housing is encapsulated by Dual In-line Package (DIP).

8. The switch apparatus of claim 1, wherein the LED housing is encapsulated by Surface-mount technology (SMT).

9. The switch apparatus of claim 1, wherein the at least one LED light source is located under the light guide pole.

10. The switch apparatus of claim 1, wherein the light guide pole is generally transparent.

11. A LED lighting apparatus, comprising:
a light emitting diode (LED) housing comprising at least one LED light source and a switch, the switch is capable of operating the LED light source; and
a light guide pole being capable of transmitting light from the at least one LED light source; the light guide pole removably embedded in the LED housing, the at least one LED light source and the switch located under the light guide pole, wherein the light guide pole is capable of pressing the switch to trigger the at least one LED light source to light by moving relative to the LED housing.

12. The LED lighting apparatus of claim 11, wherein the switch is a resilient metal piece.

13. The LED lighting apparatus of claim 12, wherein a pressing portion is formed on a bottom portion of the light guide pole.

14. The LED lighting apparatus of claim 11, wherein each LED light source produces a single light color; and a plurality of parallel LED light sources emits more than one color of light.

15. The LED lighting apparatus of claim 14, wherein a plurality of parallel LED light sources produce light with pulse-width modulation.

16. The LED lighting apparatus of claim 11, wherein the LED housing is encapsulated by Dual In-line Package (DIP).

17. The LED lighting apparatus of claim 11, wherein the LED housing is encapsulated by Surface-mount technology (SMT).

18. The LED lighting apparatus of claim 11, wherein the at least one LED light source is a three original color LED light source for emitting light with an appearance of a color different that the three original LED colors.

19. The LED lighting apparatus of claim 11, wherein the light guide pole is generally transparent.

20. The LED lighting apparatus of claim 11, wherein the light guide pole is generally translucent.
